(19) United States
(12) Patent Application Publication
(10) Pub. No.: US 2024/0403439 A1
(43) Pub. Date: Dec. 5, 2024

(54) AUTOMATIC BACKDOOR VULNERABILITY DETECTION

(71) Applicant: Dell Products L.P., Round Rock, TX (US)

(72) Inventors: Boris Shpilyuck, Ashdod (IL); Igor Dubrovsky, Beer-Sheva (IL); Nisan Haimov, Beer-Sheva (IL)

(21) Appl. No.: 18/327,129

(22) Filed: Jun. 1, 2023

(51) Int. Cl. G06F 21/57; G06F 21/55

(52) U.S. Cl. CPC G06F 21/577; G06F 21/552; G06F 21/554

(57) ABSTRACT

Technology described herein relates to managing backdoor vulnerabilities of a computer system. A system for the managing can comprise a processor, and a memory that stores executable instructions that, when executed by the processor, facilitate performance of operations, comprising analyzing system information relating to operation of an application programming interface (API); based on a result of the analyzing of the system information, constructing a call function for execution of the API and executing the call function; based on monitoring a data flow of the system with respect to the execution of the API, generating impact data representative of an impact of the execution of the API; and determining whether the impact is counter to historical functioning of the system as represented by historical functioning data.

### BACKGROUND

A backdoor vulnerability can be a security weakness in a software system that allows unauthorized access to the system. This could be in the form of hidden functionality that bypasses normal authentication and authorization procedures. Such backdoor vulnerability can pose a serious risk to the security and privacy of a system as it can provide a way for attackers to gain unauthorized access to the related computer system and potentially compromise sensitive information, such as passwords, personal data, financial information, proprietary information, etc. Likewise, such access can additionally and/or alternatively be employed to install malware, launch attacks on the computer system or other connected systems, and/or to manipulate data.

### SUMMARY

The following presents a simplified summary of the disclosed subject matter to provide a basic understanding of one or more of the various embodiments described herein. This summary is not an extensive overview of the various embodiments. It is intended neither to identify key or critical elements of the various embodiments nor to delineate the scope of the various embodiments. Its sole purpose is to present one or more concepts of the disclosure in a streamlined form as a prelude to the more detailed description that is presented later.

An example system can comprise a processor, and a memory that stores executable instructions that, when executed by the processor, facilitate performance of operations, comprising analyzing system information relating to operation of an application programming interface (API); based on a result of the analyzing of the system information, constructing a call function for execution of the API and executing the call function; based on monitoring a data flow of the system with respect to the execution of the API, generating impact data representative of an impact of the execution of the API; and determining whether the impact is counter to historical functioning of the system as represented by historical functioning data.

An example method can comprise detecting, in a data environment of a computer system operatively coupled to a processor, an unapproved impact on the computer system as a result of an execution of a call function associated with an application programming interface (API) known to the computer system, wherein detecting the unapproved impact comprises detecting a defined unapproved effect on outgoing system traffic, an initiation of system process or a generation of a system file; generating, by the system, a suggested policy in response to the unapproved impact being determined to be counter to a known function associated with the unapproved impact on the computer system, wherein the suggested policy instructs restriction of access between at least part of the API, at least part of another API other than the API, and the computer system; and instructing, by the computer system, that the suggested policy be deployed at the computer system.

An example non-transitory computer-readable medium can comprise executable instructions that, when executed by a processor, can facilitate performance of operations. The operations can comprise generating a directed graph defining discovered application programming interfaces (APIs) associated with a computer system; traversing, in a data environment, the directed graph and identifying an outgoing edge or an incoming edge of the directed graph; constructing a function call for an API of the discovered APIs and executing the function call; establishing an impact of the execution by monitoring a data flow of the system; and determining whether the impact is counter to a known functioning of the system.

An example benefit of one or more of the above-indicated method, system and/or non-transitory computer-readable medium can be an automatic vulnerability monitoring framework that can be triggered automatically upon invocation of an API, at any suitable frequency, and/or when manually triggered. The framework can account for one or more deficiencies of existing manual frameworks, including latency, manual labor, error prone user entity decision making and expense based on actual monetary cost, bandwidth, power and/or the like.

Another example benefit of one or more of the above-indicated method, system and/or non-transitory computer-readable medium can be proactive notification of a vulnerabilities detection and temporary remediation of the vulnerability. In this way, while a user entity (e.g., administrator entity or engineer entity) is reviewing the notification, constructing a patch, testing the patch, submitting the patch for approval, and/or deploying the patch, the temporary remediation can black access to an API of interest or by the API of interest to a respective computer system at which the API operates.

Still another example benefit of one or more of the above-indicated method, system and/or non-transitory computer-readable medium can be an ability to track and/or learn API-to-API dependencies, API relations, API operations and/or operation of malicious code unrelated to API invocation. This can be beneficial in cases where a single API invocation does not elicit use of a malicious code, but where invocation of two or more APIs in a sequence or at least partially in parallel does elicit use of the malicious code. In another example, this can be beneficial where an API schema document or an API source code is unavailable for review by the framework, and thus malicious code behavior is to be learned using a bottom-up approach. In still another example, this can be beneficial where a malicious code functions unrelated to an executed API, but rather can be a longer running thread and/or process.

### BRIEF DESCRIPTION OF THE DRAWINGS

The technology described herein is illustrated by way of example and not limited in the accompanying figures in which like reference numerals indicate similar elements.

FIG. 1 illustrates a block diagram of an operation system in combination with a backdoor vulnerabilities analysis system, in accordance with one or more embodiments and/or implementations described herein.

FIG. 2 illustrates a block diagram of a backdoor vulnerabilities analysis system, in accordance with one or more embodiments and/or implementations described herein.

FIG. 3 illustrates a block diagram of another backdoor vulnerabilities analysis system, in accordance with one or more embodiments and/or implementations described herein.

FIG. 4 illustrates a block diagram of inputs and outputs of the backdoor vulnerabilities analysis system of FIG. 3, in accordance with one or more embodiments and/or implementations described herein.

FIG. 5 illustrates a process flow diagram of a method of backdoor vulnerabilities analysis that can be performed by the backdoor vulnerabilities analysis system of FIG. 3, in accordance with one or more embodiments and/or implementations described herein.

FIG. 6 illustrates another process flow diagram of the method of backdoor vulnerabilities analysis of FIG. 5 that can be performed by the backdoor vulnerabilities analysis system of FIG. 3, in accordance with one or more embodiments and/or implementations described herein.

FIG. 7 illustrates a process flow diagram of another method of backdoor vulnerabilities analysis that can be performed by the backdoor vulnerabilities analysis system of FIG. 3, in accordance with one or more embodiments and/or implementations described herein.

FIG. 8 illustrates another process flow diagram of the method of backdoor vulnerabilities analysis of FIG. 7 that can be performed by the backdoor vulnerabilities analysis system of FIG. 3, in accordance with one or more embodiments and/or implementations described herein.

FIG. 9 illustrates a process flow diagram of still another method of backdoor vulnerabilities analysis that can be performed by the backdoor vulnerabilities analysis system of FIG. 3, in accordance with one or more embodiments and/or implementations described herein.

FIG. 10 illustrates another process flow diagram of the method of backdoor vulnerabilities analysis of FIG. 10 that can be performed by the backdoor vulnerabilities analysis system of FIG. 3, in accordance with one or more embodiments and/or implementations described herein.

FIG. 11 illustrates a block diagram of an example operating environment into which embodiments of the subject matter described herein can be incorporated.

FIG. 12 illustrates an example schematic block diagram of a computing environment with which the subject matter described herein can interact and/or be implemented at least in part.

### DETAILED DESCRIPTION

### Overview

The technology described herein is generally directed towards management of backdoor vulnerabilities detection such as related to vulnerabilities caused by malicious code employing an application to facilitate malicious behavior. The technology also is directed towards such vulnerabilities detection related to vulnerabilities caused by malicious code apart from application use and/or API invocation.

As used herein, a backdoor vulnerability can be a security weakness in a software system that allows unauthorized access to the system. This could be in the form of hidden functionality that bypasses normal authentication and authorization procedures. Such backdoor vulnerability can pose a serious risk to the security and privacy of a system as it can provide a way for attackers to gain unauthorized access to the related computer system and potentially compromise sensitive information, such as passwords, personal data, financial information, proprietary information, etc. Likewise, such access can additionally and/or alternatively be employed to install malware, launch attacks on the computer system or other connected systems, and/or to manipulate data.

For example, a developer can leave some code when developing an application or microservice of an application that can intercept an authentication flow on the server side and which can, as a result, send credentials to another, and unapproved, server. A vulnerability alternatively can be introduced through usage of the infected third-party library which can intercept an API call and send sensitive information to another, and unapproved, server.

Existing approaches can employ static code analysis that can analyze a source code and look for security vulnerabilities. However, such approach is inefficient and fails when backdoors are well-hidden and disguised to evade detection, making them difficult to uncover even with the use of code analysis tools.

Another existing approach can be to execute APIs against a live system that is being tested for backdoor vulnerability and to observe behavior resulting from the execution. However, his approach requires extensive manual labor, such as by an administrative or engineer entity, at least in definition of which actions should be executed. As a result, such existing approach can be error prone.

To account for one or more deficiencies of existing approaches, described herein are one or more embodiments that can automatically analyze and discover backdoor vulnerabilities through various methods, described below. As a result of the discovery, the vulnerabilities can be proactively reported, temporarily remediated and/or fully remediated. The one or more embodiments described herein can comprise execution of a plurality of process that can comprise, but are not limited to, discovery of malicious code, discovery of public APIs, determination of API dependencies, invocation of discovered APIs, analysis of post-invocation occurrences, reporting of the post-invocation occurrences, execution of temporary remediation, recommendation of policy change, and/or analysis of computer system behavior by an analytical model for vulnerabilities.

These one or more processes can avoid the manually intensive, slow, non-efficient, expensive (in terms of time, labor, actual cost, power, memory), and error prone.

The one or more embodiments described herein can be employed cooperatively with an operation system that comprises one or more computing systems having one or more hardware devices.

### Terminology

As used herein, the terms “cost” or “expense” can refer to power, money, memory and/or processing power.

As used herein, the term “data” can comprise “metadata.”

Reference throughout this specification to “embodiment,” “one embodiment,” “an embodiment,” “one implementation,” and/or “an implementation,” means that a feature, structure, or characteristic described in connection with the embodiment/implementation can be included in at least one embodiment/implementation. Thus, the appearances of such a phrase “in one embodiment,” “in an implementation,” etc. in various places throughout this specification are not necessarily all referring to the same embodiment/implementation. Furthermore, the features, structures, or characteristics may be combined in any suitable manner in one or more embodiments/implementations.

As used herein, the terms “employing” or “employed by” can refer to an element (e.g., a hardware device) that is currently being employed, that has already been employed and/or that is to be employed.

As used herein, the term “entity” can refer to a machine, device, smart device, component, hardware, software and/or human.

A “group” can refer to a subset of hardware devices of an operation system, which hardware devices can comprise, but are not limited to, storage nodes, switch nodes, server nodes and/or assembly devices, and which operation system can comprise one or more computing systems.

As used herein, with respect to any aforementioned and below mentioned uses, the term “in response to” can refer to any one or more states including, but not limited to: at the same time as, at least partially in parallel with, at least partially subsequent to and/or fully subsequent to, where suitable.

As used herein, the term “power” can refer to electrical and/or other source of power available to the operation system.

As used herein, the term “resource” can refer to power, money, memory, bandwidth, processing power, hardware and/or software.

### Example Architectures

One or more embodiments are now described with reference to the drawings, where like referenced numerals are used to refer to like elements throughout. In the following description, for purposes of explanation, numerous specific details are set forth to provide a more thorough understanding of the one or more embodiments. It is evident, however, in various cases, that the one or more embodiments can be practiced without these specific details.

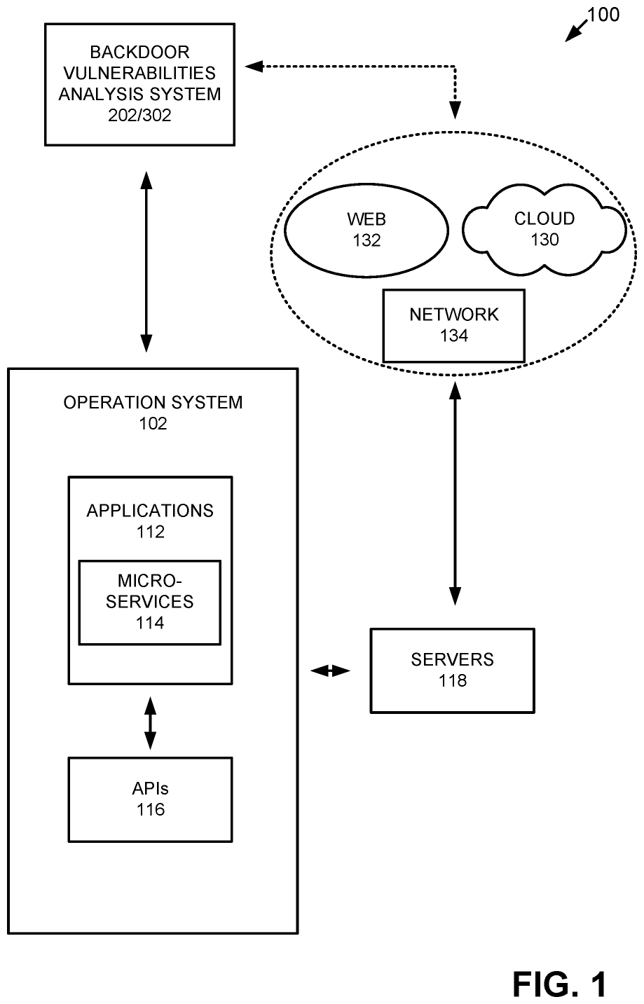

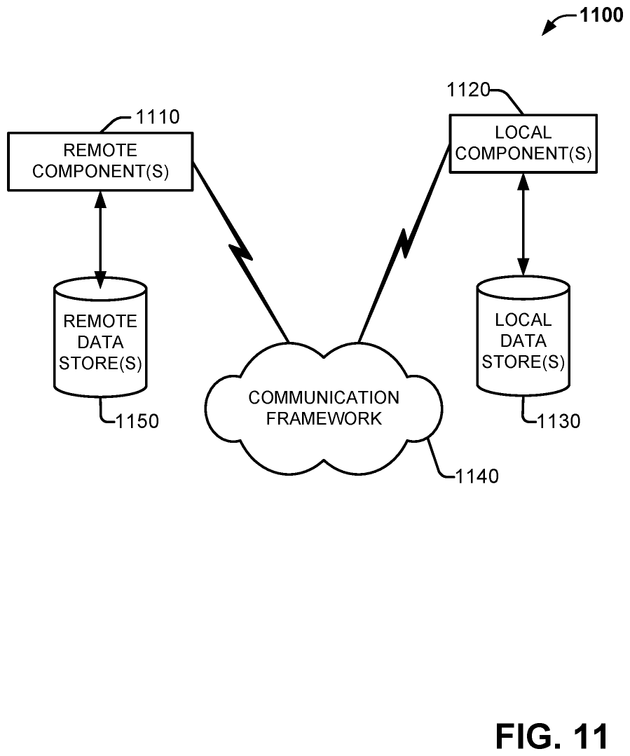

Further, the embodiments depicted in one or more figures described herein are for illustration only, and as such, the architecture of embodiments is not limited to the systems, devices and/or components depicted therein, nor to any order, connection and/or coupling of systems, devices and/or components depicted therein. For example, in one or more embodiments, the non-limiting system architectures described, and/or systems thereof, can further comprise one or more computer and/or computing-based elements described herein with reference to an operating environment, such as the operating environment 1100 illustrated at FIG. 11. In one or more described embodiments, computer and/or computing-based elements can be used in connection with implementing one or more of the systems, devices, components and/or computer-implemented operations shown and/or described in connection with FIGS. 1-10 and/or with other figures described herein.

Turning first to FIG. 1, a non-limiting architecture 100 is illustrated comprising an operation system 102, a backdoor vulnerabilities system 202/302, a plurality of servers 118 and externally communicating aspects such as a web service 132, a cloud service 130 and/or a network 134. The operation system 102 can comprise one or more applications 112 that employ and/or comprise one or more microservices 114 and which are associated with one or more respective application programming interfaces (APIs) 116. In one or more embodiments, one or more microservices can be separate from the one or more applications 112. The operation system 102, and particularly the applications 112 and/or micro-services 114 thereof, can obtain access to the externally communicating aspects such as a web service 132, a cloud service 130 and/or a network 134 such as by way of one or more of the servers 118 (e.g., cloud servers, network servers and/or web servers). In one or more embodiments, the backdoor vulnerabilities analysis system 202 can be supplemented by and/or replaced by the backdoor vulnerabilities analysis system 302 to be described below. The backdoor vulnerabilities analysis system 202/302, in one or more other embodiments, can be at least partially internal to the operation system 102.

The operation system 102 further can comprise plural hardware devices (e.g., components) such as storage nodes, switch nodes, server nodes and/or other devices.

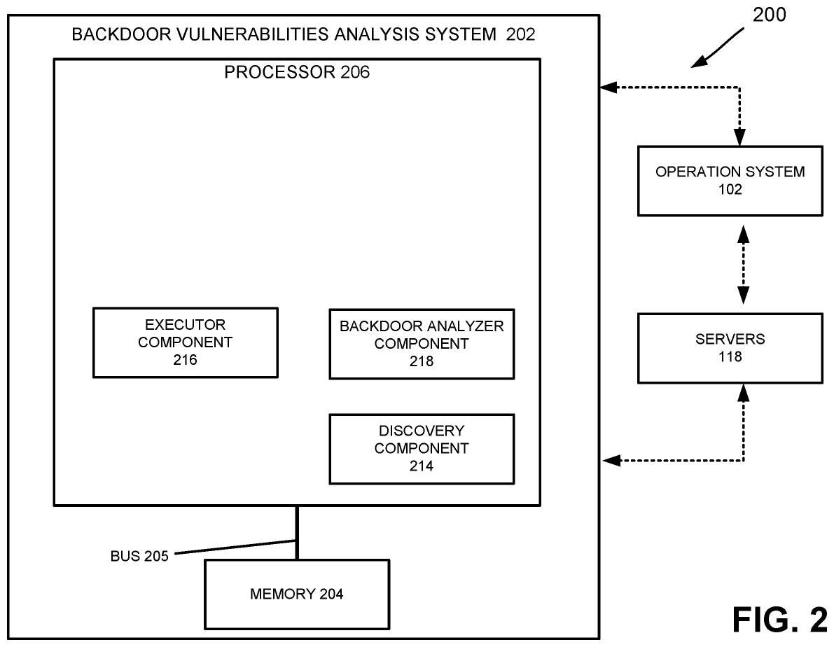

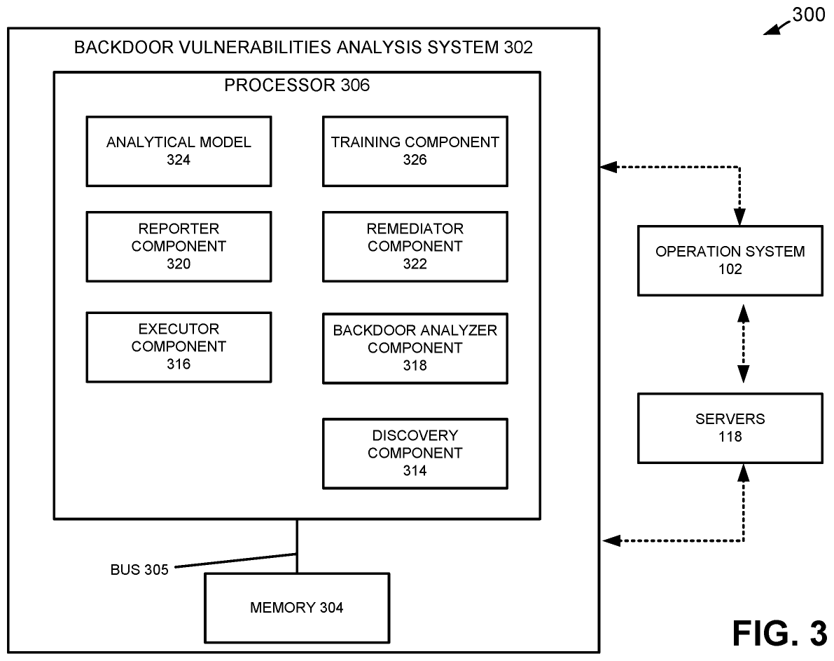

The backdoor vulnerabilities analysis system 202/302 can generally monitor and for and analyze backdoor vulnerabilities of the operation system 102, such as caused by malicious code. The backdoor vulnerabilities analysis system 202/302 can function at any suitable frequency, such as upon each invocation of an API 116, upon each access to a server 118, at a selected frequency, and/or upon manual invocation of the backdoor vulnerabilities analysis system 202/302. The backdoor vulnerabilities analysis system 202/302 be described in detail below, relative to FIGS. 2 and 3.

The operation system 102 and the backdoor vulnerabilities analysis system 202/302 can be operably coupled by any suitable connection, network, cloud application and/or cloud service.

For example, communication can be by any suitable method. Communication can be facilitated by wired and/or wireless methods including, but not limited to, employing a cellular network, a wide area network (WAN) (e.g., the Internet), and/or a local area network (LAN). Suitable wired or wireless technologies for facilitating the communications can include, without being limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), high speed packet access (HSPA), ZIGBEE® and other 802.XX wireless technologies and/or legacy telecommunication technologies, BLUETOOTH®, Session Initiation Protocol (SIP), radio frequency for consumer electronics (RF4CE) protocol, wireless highway addressable remote transducer (WirelessHART) protocol, internet protocol version 6 (Ipv6) over Low power Wireless Area Networks (6LoWPAN), Z-Wave, an adaptive network technology (ANT) protocol, an ultra-wideband (UWB) standard/protocol and/or other proprietary and/or non-proprietary communication protocols.

Turning next to FIG. 2, an architecture 200 is illustrated comprising the backdoor vulnerabilities analysis system 202 and the operation system 102 and servers 118. While referring here to one or more processes, operations, facilitations and/or uses of the non-limiting system architecture 200, description provided herein, above and/or below also can be relevant to one or more other non-limiting system architectures described herein (e.g., 100 and/or 300). Repetitive description of like elements and/or processes employed in respective embodiments is omitted for sake of brevity. Further, the backdoor vulnerabilities analysis system 202 is described only briefly, with further details of an operation management system instead being provided below relative to the backdoor vulnerabilities analysis system 302.

As illustrated, the backdoor vulnerabilities analysis system 202 can be communicatively coupled to the operation system 102 for sending and receiving data therebetween. In one or more embodiments, the backdoor vulnerabilities analysis system 202 can be at least partially comprised by the operation system 102.

Generally, the backdoor vulnerabilities analysis system 202 can manage monitoring of and analysis of backdoor vulnerabilities of the operation system 102, such as caused by malicious code, employing one or more APIs 114 of the operation system 102 and/or separate from the one or more APIs 114 of the operation system 102. The backdoor vulnerabilities analysis system 202 can comprise any suitable computing devices, hardware, software, operating systems, drivers, network interfaces and/or so forth. For example, the backdoor vulnerabilities analysis system 202 can comprise a processor 206 and a memory 204 communicatively coupled by a bus 205. The processor 206 can comprise a discovery component 214, an executor component 216 and/or a backdoor analyzer component 218. In one or more other embodiments, the discovery component 214, the executor component 216 and/or the backdoor analyzer component 218 can be disposed external to the processor 206.

The discovery component 214 can generally analyze system information relating to operation of an application programming interface (API), and in response, based on a result of the analyzing, the executor component 216 can construct and invoke a call function for execution of the API. In response to the invocation of the API, the backdoor analyzer component 218 can monitor a data flow of the operation system 102 with respect to the execution of the API. The backdoor analyzer component 218 also can generate impact data representative of an impact of the execution of the API. In one or more embodiments, the backdoor analyzer component 218 can determine whether the impact is counter to historical functioning of the operation system 102 (e.g., known function) as represented by historical functioning data of the operation system 102.

Turning next to FIG. 3, a non-limiting architecture 300 is illustrated comprising a backdoor vulnerabilities analysis system 302 that can function to manage monitoring of and analysis of backdoor vulnerabilities of the operation system 102, such as caused by malicious code, employing one or more APIs 114 of the operation system 102 and/or separate from the one or more APIs 114 of the operation system 102. In one or more embodiments, the backdoor vulnerabilities analysis system 302 can be comprised by the operation system 102. While referring here to one or more processes, operations, facilitations and/or uses of the non-limiting system 300, description provided herein, above and/or below also can be relevant to one or more other non-limiting system architectures described herein (e.g., 100 and/or 200). Repetitive description of like elements and/or processes employed in respective embodiments is omitted for sake of brevity.

Generally, the backdoor vulnerabilities analysis system 302 can comprise any suitable computing devices, hardware, software, operating systems, drivers, network interfaces and/or so forth. As illustrated, the backdoor vulnerabilities analysis system 302 can comprise a discovery component 314, executor component 316, backdoor analyzer component 318, reporter component 320, remediator component 322, analytical model 324 and/or training component 326. These components can be comprised by a processor 306 and/or one or more of these components can be external to the processor 306. A bus 305 operatively couples the processor 306 and a memory 304.

Communication among the components of the backdoor vulnerabilities analysis system 302 can be by any suitable method. Communication can be facilitated by wired and/or wireless methods including, but not limited to, employing a cellular network, a WAN (e.g., the Internet), and/or a LAN. Suitable wired or wireless technologies for facilitating the communications can include, without being limited to, Wi-Fi, GSM, UMTS, WiMAX, enhanced GPRS, 3GPPLTE, 3GPP2UMB, HSPA, ZIGBEE® and other 802.XX wireless technologies and/or legacy telecommunication technologies, BLUETOOTH®, SIP, RF4CE protocol, WirelessHART protocol, 6LoWPAN, Z-Wave, an ANT protocol, a UWB standard/protocol and/or other proprietary and/or non-proprietary communication protocols.

Discussion first turns to the processor 306, memory 304 and bus 305 of the backdoor vulnerabilities analysis system 302.

In one or more embodiments, the backdoor vulnerabilities analysis system 302 can comprise a processor 306 (e.g., computer processing unit, microprocessor, classical processor and/or like processor). In one or more embodiments, the processor 306 can be and/or be comprised by a controller.

In one or more embodiments, a component associated with backdoor vulnerabilities analysis system 302, as described herein with or without reference to the one or more figures of the one or more embodiments, can comprise one or more computer and/or machine readable, writable and/or executable components and/or instructions that can be executed by processor 306 to facilitate performance of one or more processes defined by such component and/or instruction.

In one or more embodiments, the backdoor vulnerabilities analysis system 302 can comprise a machine-readable memory 304 that can be operably connected to the processor 306. The memory 304 can store computer-executable instructions that, upon execution by the processor 306, can cause the processor 306 and/or one or more other components of the backdoor vulnerabilities analysis system 302 to perform one or more actions. In one or more embodiments, the memory 304 can store computer-executable components.

The backdoor vulnerabilities analysis system 302 and/or a component thereof as described herein, can be communicatively, electrically, operatively, optically and/or otherwise coupled to one another via a bus 305 to perform functions of non-limiting system architecture 300, backdoor vulnerabilities analysis system 302 and/or one or more components thereof and/or coupled therewith. Bus 305 can comprise one or more of a memory bus, memory controller, peripheral bus, external bus, local bus and/or another type of bus that can employ one or more bus architectures. One or more of these examples of bus 305 can be employed to implement one or more embodiments described herein.

In one or more embodiments, backdoor vulnerabilities analysis system 302 can be coupled (e.g., communicatively, electrically, operatively, optically and/or like function) to one or more external systems (e.g., a system management application), sources and/or devices (e.g., classical communication devices and/or like devices), such as via a network. In one or more embodiments, one or more of the components of the backdoor vulnerabilities analysis system 302 can reside in the cloud, and/or can reside locally in a local computing environment (e.g., at a specified location).

In addition to the processor 306 and/or memory 304 described above, the backdoor vulnerabilities analysis system 302 can comprise one or more computer and/or machine readable, writable and/or executable components and/or instructions that, when executed by processor 306, can facilitate performance of one or more operations defined by such component and/or instruction.

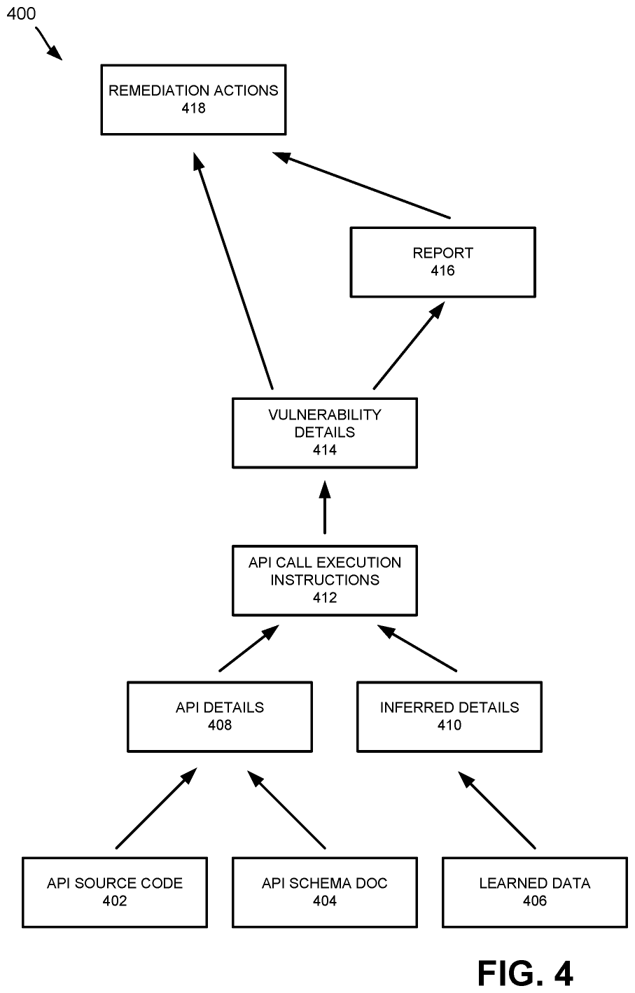

Direction first turns to the discovery component 314 which can receive, transmit, locate, identify and/or otherwise obtain various data (e.g., including metadata) that can be employed by at least the executor component 316 and backdoor analyzer component 318. This data can comprise data related to parameters, capabilities, configurations, availability of resources, configurations and/or impact assessments of the operation system 102, such as to define a historical understanding of operations of the operation system 102. In one or more embodiments, this data can comprise data representing dependencies of amongst applications, APIs and/or microservices. Referring continuously now to FIG. 4 along with FIG. 3, this data further can comprise one or more API source code 402, API schema documents 404 and/or other source code and/or schema documents of the operation system 102. As used herein, a schema document can refer to a file or other data structure that can define how data is translated, used, parsed, etc.

In one or more embodiments, the discovery component 314 can search and/or otherwise analyze the source code 402 and/or the schema document 404. This search and/or analysis can lead to API details 408 defined by data that can be employed by the executor component 316. The discovered API details 408 from analyzed source code and/or analyzed schema doc can comprise information that can be relevant to one or more protocols in use by the operation system 102 such as one or more universal resource identifiers (URIs), query parameters, path parameters, protocol method, protocol request and/or response headers, protocol request and/or response bodies, types and/or ranges of values in the request and/or response bodies, and/or whether each of these fields is required or optional for the protocol.

Related to analysis of an API source code, data related to the aforementioned fields can be inferred based on API details contained in the API source code. For example, if an application is using a particular framework, the discovery component 314 can search for one or more annotations to determine information for calling a related API.

In one or more embodiments, there can be dependencies amongst applications, and/or among APIs. For example, invocation of a first API or a second API can lead to results consistent with a state of non-vulnerability of the operation system 102. However, if the first API and the second API are invoked in a sequence or at least partially at the same time as one another, monitored results can lead to discovery of a vulnerability state consistent with the possibility of a backdoor vulnerability.

In one example, if the operation system 102 comprises and/or generates product categories and products, a product can be created under specific category that is identified by category ID. Meaning, an API call for product API creation cannot be autogenerated with an arbitrary category ID. In such case, autogenerated with an arbitrary category ID, the product creation API invocation will likely fail on the validation in the beginning of the flow causing the backdoor analyzer component 318 to miss a hidden vulnerability that resides in product creation API. Differently, invocation of an API call for creation of the category, taking category ID from the response and passing the category ID to product creation API, based on a dependency between the product creation API and category API, can allow for the product creation API invocation to succeed. This can allow for the backdoor analyzer component 318 to monitor a vulnerability that resides in product creation API.

Such dependencies can be learned by the discovery component 314 with or without use of an analytical model 324 (e.g., inferential model, predictive model, neural network, and/or artificial intelligence (AI) model), to be explained in further detail below.

For example, a result of analysis (e.g., scanning) of one or more API schema documents can be the generation of a directed graph that can be traversed, in a data environment, by the discovery component 314 and/or the executor component 316, to identify an outgoing edge or incoming edge of the directed graph, e.g., by mapping interactions between the vertices.

That is, consider a directed graph G(V,E), where a group of vertexes V comprises discovered APIs and a group of edges E comprises edges represented as pairs of vertexes [v(x)->v(y)] where invocation of v(x) depends on v(y). In addition, each edge can have an associated therewith information regarding which fields of v(x) depend on which fields of v(y). This information can be represented as a dictionary D[source_field, target_field]. That is, invocation of a first vertex of a pair of vertices can be dependent upon invocation of a second vertex of the pair of vertices.

By traversing the directed graph G in a bottom-up direction (e.g., from the vertexes that do not have dependencies and up the hierarchy, an outgoing edge can be discovered. If a vertex does not have an outgoing edge (meaning the API is not dependent upon another API), the API can be executed by the executory component 316, with a response R being stored in the current vertex. On the other hand, if the current vertex has one or more outgoing edges (meaning the API is dependent upon one or more other APIs), per each edge the corresponding dictionary D[source_field, target_field] can be examined in order to fetch a source fields' values from response R in a downstream vertex and put them as target fields' values in the currently generated API request. The fields that are not related to other requests can be autogenerated. Finally, the API can be executed by the executor component 316, and result R can be stored in the current vertex. This recursive flow can continue until no unhandled vertexes remain.

It is noted that the executor component 316 will be discussed below in greater detail.

In another example, the processes of which can be employed alternatively to or in addition to the use of directed graphs, there can be a situation where an API schema document or API source code does not provide sufficient information, or a situation where an API schema document or API source code is unavailable. To overcome this situation, the discover component 314 can employ the analytical model 324. The analytical model 324 can observe interactions of the operation system 102 and, as a result, infer one or more dependencies of one or more APIs. Such interactions and/or API calls can be observed, for example, from API gateway access logs, web server access log, and/or application of network sniffers relative to configuration of non-transport layer security (non-TLS) traffic for testing purposes. These API interactions can be employed to generate a directed graph G, as explained above.

Turning now to specifics of the aforementioned analytical model 324, in one or more embodiments, the backdoor vulnerabilities analysis system 302 can comprise an analytical model 324. The analytical model 324 can be, can comprise and/or can be comprised by a classical model, such as an inferential model, predictive model, neural network, and/or artificial intelligence (AI) model. An artificial intelligent model and/or neural network (e.g., a convolutional network and/or deep neural network) can comprise and/or employ AI, machine learning (ML), and/or deep learning (DL), where the learning can be supervised, semi-supervised, self-supervised, semi-self-supervised and/or unsupervised. For example, the analytical model 324 can comprise an ML model.

The analytical model 324 generally can evaluate known data, such as historical data relating to known (e.g., historical) functioning of the operation system 102, and/or relating to known malicious code and/or programs, files, microservices, and/or applications known to be associated with malicious code. In one or more cases, the analytical model 324 can aid the discovery component 314 in monitoring behavior of the operation system 102, learning one or more dependencies among APIs and/or microservices, learning system operation norms, and/or identifying one or more occurrences of the operation system 102 that are counter to the observed norms (e.g., possibly related to a backdoor vulnerability). In one or more cases, the analytical model 324 can aid the remediator component 322 by determining a remediation action 418 to correspond to a discovered vulnerability based on one or more vulnerability details 414.

Alternatively, it will be appreciated that the backdoor vulnerabilities analysis system 302 can function absent use of the analytical model 324.

Where in use, the analytical model 324 can be trained, such as by a training component 326, on a set of training data that can represent the type of data for which the backdoor vulnerabilities analysis system 302 will be used. That is, the analytical model 324 can be trained on historical and/or current data comprising operation system 102 parameters, capabilities, configurations, availability of resources, configurations and/or impact assessments. The analytical model 324 can be trained on training input comprising source field values of pairs of dependent APIs of the discovered APIs.

By employing the training component 326, the backdoor vulnerabilities analysis system 302 can be self-improving by continually learning of new, dynamic and/or evolving functionalities of the operation system, malicious code and/or types of vulnerabilities. In this way, the b backdoor vulnerabilities analysis system 302 can better perform monitoring and analysis for vulnerabilities in future system executions.

Next, the executor component 316, based on the data uncovered by the discovery component 314 (e.g., API details 408) and/or inferred details 410 uncovered by the discovery component 314/executory component 316 based on directed graph construction and/or use of the analytical model 324, can construct one or more API call execution instructions 412 for a call function for execution of one or more APIs 114. In one or more embodiments, the executor component 316 also can execute the call function, thereby invoking the API.

In one or more embodiments, the backdoor analyzer component 318 can be triggered, such as by the executor component 316, after, before, during and/or otherwise in response to each API call executed.

In response to being triggered, the backdoor analyzer component 318 can generally monitor one or more data flows of the operation system 102 of which the backdoor analyzer component 318 can access. This monitoring can comprise scanning the application related to the API call for possible backdoor vulnerabilities (e.g., for vulnerability details 414 defined by related vulnerability data). This scanning can include determining one or more aspects that can be related to a vulnerability, such as, but not limited to, outgoing traffic to a destination, a process that is initiated, and/or a file created. For example, the backdoor analyzer component 318 can determine if outgoing traffic is to a destination that is not related to the known/historical data discovered by the discovery component 314 and/or if the destination is on database of malicious sites, locations, etc. Such database can be obtained using any suitable method by the operation system 102 and/or discovery component 314. Indeed, many such databases can be publicly available.

In another example, the backdoor analyzer component 318 additionally and/or alternatively can determine if a process has been started by and/or in the application, whether the process is related to the known/historical data discovered by the discovery component 314 and/or if the process name appears in a database of malicious processes. Such database can be obtained using any suitable method by the operation system 102 and/or discovery component 314. Indeed, many such databases can be publicly available.

In still another example, the backdoor analyzer component 318 additionally and/or alternatively can determine if a file has been created by and/or in the application, whether the file is related to the known/historical data discovered by the discovery component 314 and/or if the file name appears in a database of malicious files. Such database can be obtained using any suitable method by the operation system 102 and/or discovery component 314. Indeed, many such databases can be publicly available.

In yet another example, a malicious code can be additionally and/or alternatively executed as a long-running thread and/or process without any relation to an executed API request. In such situation, such malicious code may not have access to some data that passes through API invocations but still can attack other areas within and/or external to an application.

In an exemplary situation, in a framework-based system, a framework itself can have the responsibility to load and execute a piece of code that is marked, such as automatically, such as periodically according to a schedule.

Accordingly, to discover a backdoor vulnerability related thereto, the backdoor analyzer component 318 can again scan one or more data flows to determine one or more aspects that can be related to a vulnerability, such as, but not limited to, outgoing traffic to a destination, a process that is initiated, and/or a file created.

Additionally, and/or alternatively, using backtracking, the backdoor analyzer component 318 can determine a source code portion that was employed to generate the result corresponding to a possible backdoor vulnerability. That is, based on the analysis above, in such situation, the backdoor analyzer component 318 can identify a microservice or monolith and a list of possible code portions within that microservice/monolith where a vulnerability can reside. In one or more embodiments, the final results can be written to a report 416 for review by an entity associated with the backdoor vulnerability analysis system 302 and/or operation system 102 to review the output.

It is noted that such scanning related to a long-running thread and/or process can be performed at least partially in parallel with scanning based on one or more API invocations.

Once a vulnerability is found, e.g., where API details 408/inferred details 410 and vulnerability details 414 align, the backdoor analyzer component 318 can generate impact data comprising results of monitoring of the outgoing system traffic, initiation of one or more system processes and/or generation of one or more files. That is, the impact data can be generated when the impact is determined as being counter to the historical functioning of the system (e.g., the alignment of the API details 408/inferred details 410 and vulnerability details 414).

Further, the backdoor analyzer component 318 can trigger the reporter component 320, and/or the reporter component 320 can be otherwise triggered. The reporter component 320 can generate a report 416 that can be transmitted, such as by the reporter component 320 to any suitable reporting end location, such as to a device corresponding to an administrator entity and/or engineering entity related to the operation system 102.

Turning next to remediation based on the impact data, and/or on the vulnerability details 414 on which the impact data is based, in one or more embodiments, the backdoor vulnerabilities analysis system 302 can comprise a remediator component 322. Generally, the remediator component 322 can perform one or more processes to remediate (e.g., at least temporarily) a discovered vulnerability of the operation system 102.

In one or more embodiments, the remediator component 322 can initiate execution of instructions that block access to an API, such as via modification of a markup language configuration associated with the API or of a service server configuration corresponding to the API. That is, in one or more embodiments, relative to a service mesh, the remediator component 322 can directly and/or indirectly disable the access to a specific API through a markup language configuration. The actual enforcement based on the supplied configuration can take place at a sidecar proxy of the service mesh without the need for changing the code.

In one or more embodiments, in the case of a legacy-like system that can be running as one or more monolith applications, the remediator component 322 can directly and/or indirectly apply a restriction without introducing code modifications. This can be achieved through updating of the relevant configuration files of the corresponding server (e.g., web server) that is often placed in front of such legacy-like systems.

In one or more embodiments, additionally or alternatively, the remediator component 322 can generate a suggested policy in response to an unapproved impact being determined to be counter to a known function associated with the unapproved impact on the operation system 102. The suggested policy can instruct restriction of access between at least part of the API, at least part of another API other than the API, and the operation system 102. The remediator component 322 further can instruct that the policy be deployed at the operation system 102 or at a server 118 that facilitates use of the API, such as by use of a report 416 generated by the reporter component 320.

That is, when a backdoor vulnerability is discovered, a course of action can be to allocate an engineer entity to patch the respective code, run a build (CI/CD or legacy build system), and deploy the build artifact to the system. However, this process can be cumbersome and potentially time-consuming, such vulnerability can be discovered during non-working hours of such engineering entity, and/or the CI/CD pipeline might be not stable so there can be a delay with producing the patched artifact.

Accordingly, the remediator component 230 can account for one or more of these deficiencies. As a result, one or more backdoor vulnerabilities can be blocked through an automated process, thus mitigating the risk and giving an entity time for generating an appropriate code patch.

### Example Operations

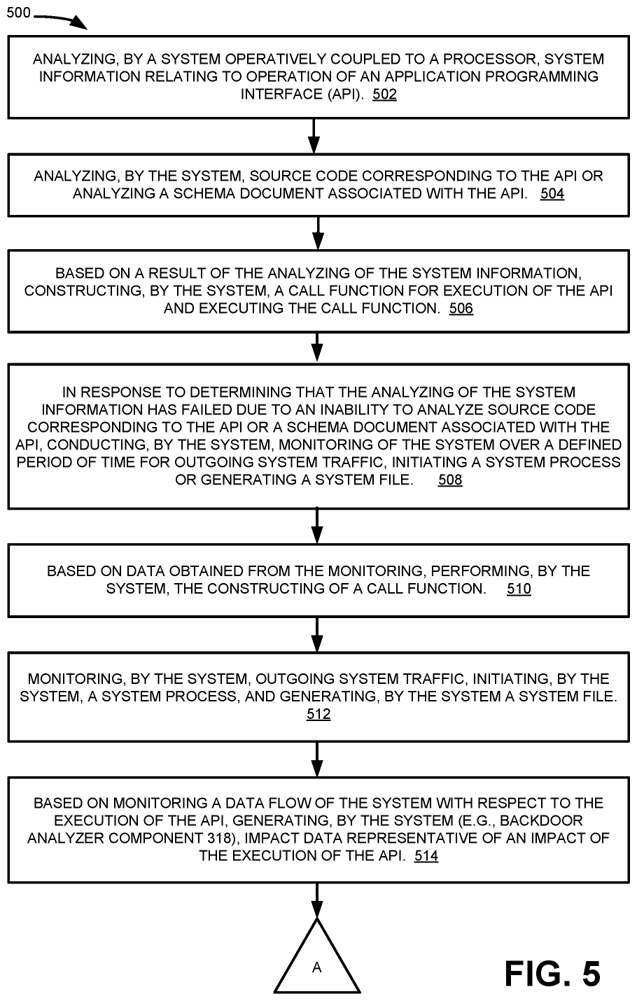

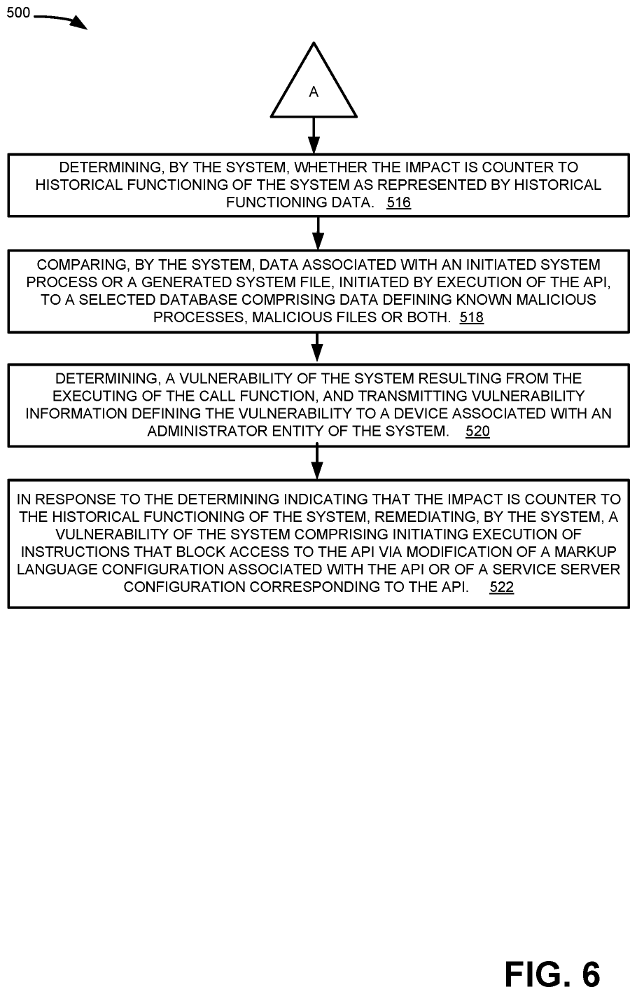

Turning now to FIGS. 5 and 6, a process flow comprising a set of operations for monitoring and analyzing backdoor vulnerabilities of an operation system is set forth relative to FIGS. 1-4. One or more elements, objects and/or components referenced in the process flow 500 can be those of schematics 100-400. While the process flow 500 references one or more aspects of the backdoor vulnerabilities analysis system 302 of FIG. 3, the process flow 500 is likewise applicable to the backdoor vulnerabilities analysis system 202 of FIG. 2. Repetitive description of like elements and/or processes employed in respective embodiments is omitted for sake of brevity.

At operation 502, the process flow 500 can comprise analyzing, by a system operatively coupled to a processor (e.g., discovery component 314), system information relating to operation of an application programming interface (API).

At operation 504, the process flow 500 can comprise analyzing, by the system (e.g., discovery component 314), source code corresponding to the API or analyzing a schema document associated with the API.

At operation 506, the process flow 500 can comprise, based on a result of the analyzing of the system information, constructing, by the system (e.g., executor component 316), a call function for execution of the API and executing the call function.

At operation 508, the process flow 500 can comprise, in response to determining that the analyzing of the system information has failed due to an inability to analyze source code corresponding to the API or a schema document associated with the API, conducting, by the system (e.g., backdoor analyzer component 318), monitoring of the system over a defined period of time for outgoing system traffic, initiating a system process or generating a system file.

At operation 510, the process flow 500 can comprise, based on data obtained from the monitoring, performing, by the system (e.g., executor component 316), the constructing of a call function.

At operation 512, the process flow 500 can comprise, monitoring, by the system (e.g., backdoor analyzer component 318), outgoing system traffic, initiating, by the system (e.g., backdoor analyzer component 318), a system process, and generating, by the system (e.g., backdoor analyzer component 318), a system file.

At operation 514, the process flow 500 can comprise, based on monitoring a data flow of the system with respect to the execution of the API, generating, by the system (e.g., backdoor analyzer component 318), impact data representative of an impact of the execution of the API.

At operation 516, the process flow 500 can comprise determining, by the system (e.g., backdoor analyzer component 318), whether the impact is counter to historical functioning of the system as represented by historical functioning data.

At operation 518, the process flow 500 can comprise comparing, by the system (e.g., backdoor analyzer component 318), data associated with an initiated system process or a generated system file, initiated by execution of the API, to a selected database comprising data defining known malicious processes, malicious files or both.

At operation 520, the process flow 500 can comprise determining, by the system (e.g., backdoor analyzer component 318), a vulnerability of the system resulting from the executing of the call function and transmitting vulnerability information defining the vulnerability to a device associated with an administrator entity of the system.

At operation 522, the process flow 500 can comprise, in response to the determining indicating that the impact is counter to the historical functioning of the system, remediating, by the system (e.g., remediator component 322), a vulnerability of the system comprising initiating execution of instructions that block access to the API via modification of a markup language configuration associated with the API or of a service server configuration corresponding to the API.

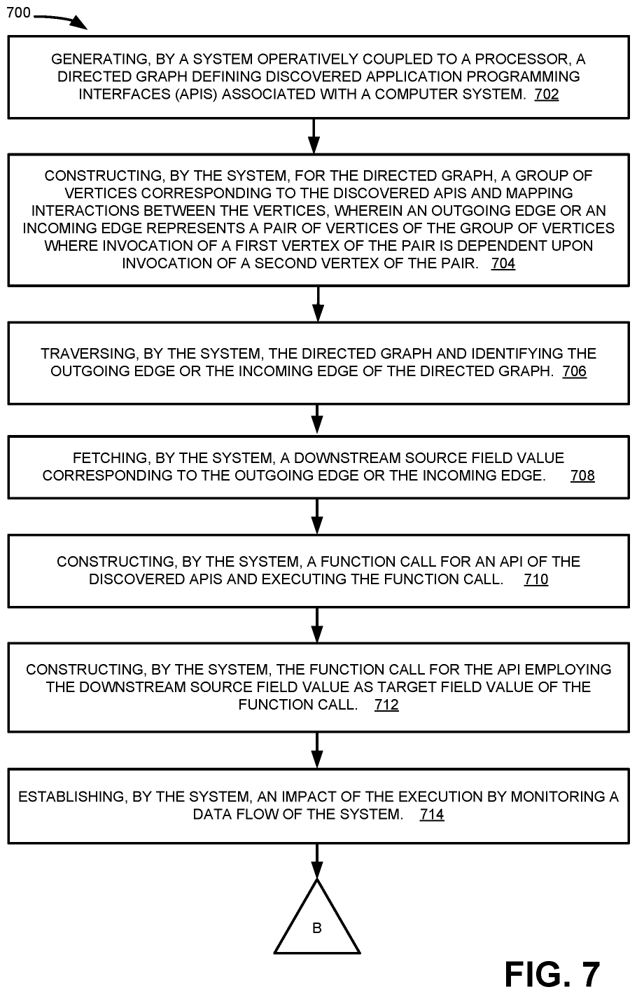

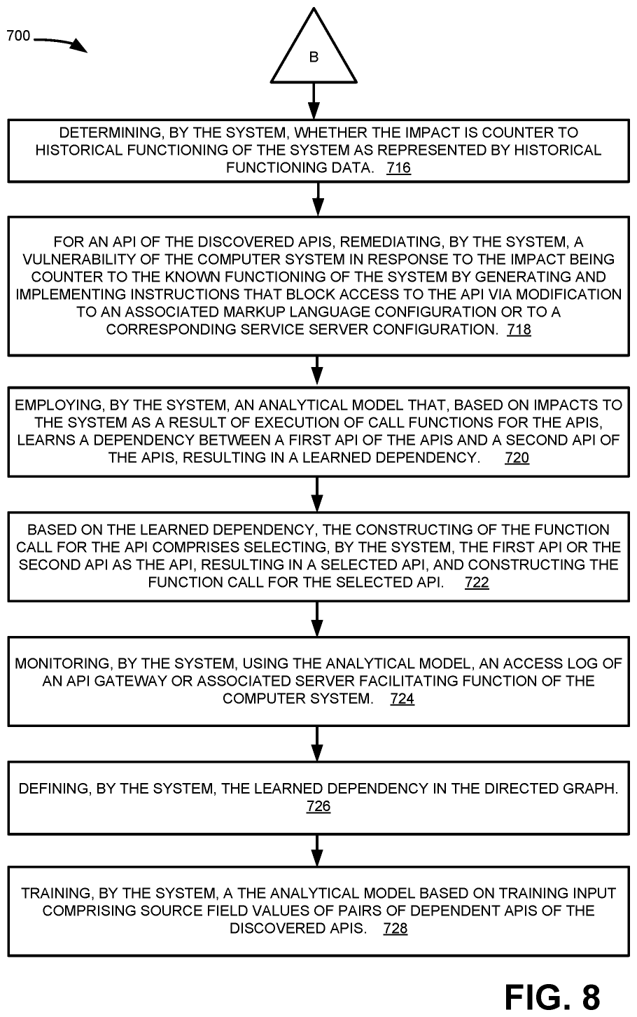

Turning now to FIGS. 7 and 8, a process flow comprising a set of operations for monitoring and analyzing backdoor vulnerabilities of an operation system is set forth relative to FIGS. 1-4. One or more elements, objects and/or components referenced in the process flow 700 can be those of schematics 100-400. While the process flow 700 references one or more aspects of the backdoor vulnerabilities analysis system 302 of FIG. 3, the process flow 700 is likewise applicable to the backdoor vulnerabilities analysis system 202 of FIG. 2. Repetitive description of like elements and/or processes employed in respective embodiments is omitted for sake of brevity.

At operation 702, the process flow 700 can comprise generating, by a system operatively coupled to a processor (e.g., discovery component 314), a directed graph defining discovered application programming interfaces (APIs) associated with a computer system.

At operation 704, the process flow 700 can comprise constructing, by the system (e.g., discovery component 314), for the directed graph, a group of vertices corresponding to the discovered APIs and mapping interactions between the vertices, wherein an outgoing edge or an incoming edge represents a pair of vertices of the group of vertices where invocation of a first vertex of the pair is dependent upon invocation of a second vertex of the pair.

At operation 706, the process flow 700 can comprise, traversing, by the system (e.g., discovery component 314), the directed graph and identifying the outgoing edge or the incoming edge of the directed graph.

At operation 708, the process flow 700 can comprise, fetching, by the system (e.g., discovery component 314), a downstream source field value corresponding to the outgoing edge or the incoming edge.

At operation 710, the process flow 700 can comprise, constructing, by the system (e.g., executor component 316), a function call for an API of the discovered APIs and executing the function call.

At operation 712, the process flow 700 can comprise, constructing, by the system (e.g., executor component 316), the function call for the API employing the downstream source field value as target field value of the function call.

At operation 714, the process flow 700 can comprise, establishing, by the system (e.g., backdoor analyzer component 318), an impact of the execution by monitoring a data flow of the system.

At operation 716, the process flow 700 can comprise determining, by the system (e.g., backdoor analyzer component 318), whether the impact is counter to historical functioning of the system as represented by historical functioning data.

At operation 718, the process flow 700 can comprise, for an API of the discovered APIs, remediating, by the system (e.g., remediator component 322), a vulnerability of the computer system in response to the impact being counter to the known functioning of the system by generating and implementing instructions that block access to the API via modification to an associated markup language configuration or to a corresponding service server configuration.

At operation 720, the process flow 700 can comprise, employing, by the system (e.g., backdoor analyzer component 318), an analytical model (e.g., analytical model 324) that, based on impacts to the system as a result of execution of call functions for the APIs, learns a dependency between a first API of the APIs and a second API of the APIs, resulting in a learned dependency.

At operation 722, the process flow 700 can comprise, based on the learned dependency, the constructing of the function call for the API comprises selecting, by the system (e.g., executor component 316), the first API or the second API as the API, resulting in a selected API, and constructing the function call for the selected API.

At operation 724, the process flow 700 can comprise, monitoring, by the system (e.g., backdoor analyzer component 318), using the analytical model, an access log of an API gateway or associated server facilitating function of the computer system.

At operation 726, the process flow 700 can comprise, defining, by the system (e.g., backdoor analyzer component 318), the learned dependency in the directed graph.

At operation 728, the process flow 700 can comprise, training, by the system (e.g., training component 326), the analytical model based on training input comprising source field values of pairs of dependent APIs of the discovered APIs.

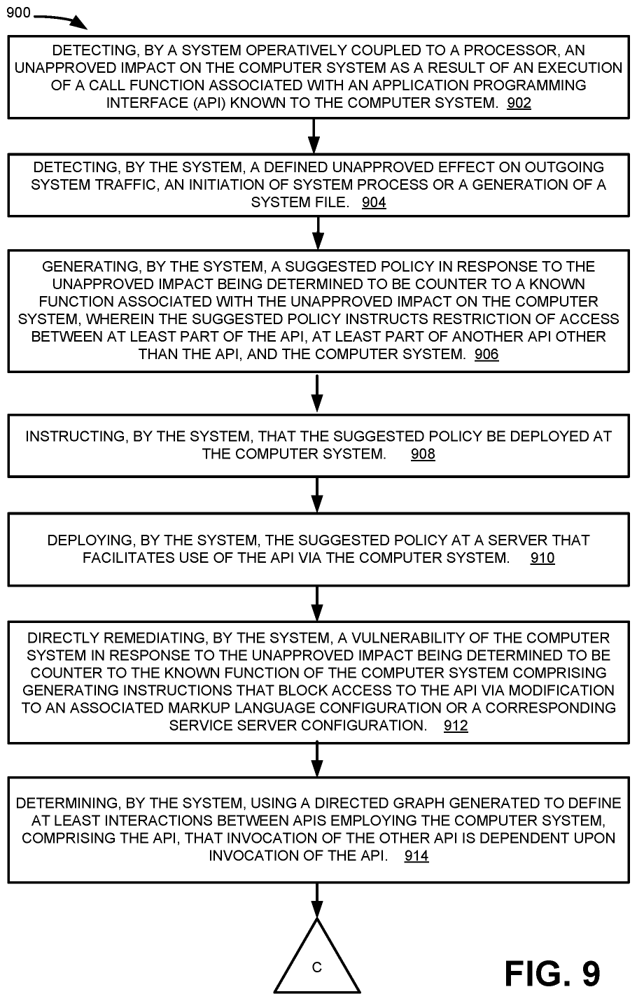

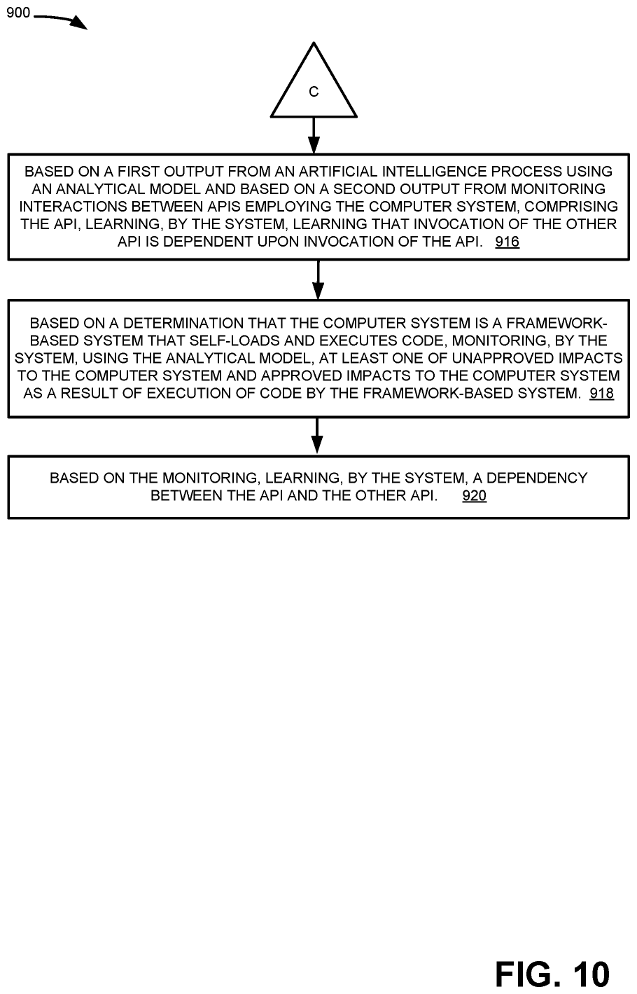

Turning now to FIGS. 9 and 10, a process flow comprising a set of operations for monitoring and analyzing backdoor vulnerabilities of an operation system is set forth relative to FIGS. 1-4. One or more elements, objects and/or components referenced in the process flow 900 can be those of schematics 100-400. While the process flow 900 references one or more aspects of the backdoor vulnerabilities analysis system 302 of FIG. 3, the process flow 900 is likewise applicable to the backdoor vulnerabilities analysis system 202 of FIG. 2. Repetitive description of like elements and/or processes employed in respective embodiments is omitted for sake of brevity.

At operation 902, the process flow 900 can comprise detecting, by a system operatively coupled to a processor (e.g., backdoor analyzer component 318), an unapproved impact on the computer system as a result of an execution of a call function associated with an application programming interface (API) known to the computer system.

At operation 904, the process flow 900 can comprise detecting, by the system (e.g., backdoor analyzer component 318), a defined unapproved effect on outgoing system traffic, an initiation of system process or a generation of a system file.

At operation 906, the process flow 900 can comprise, generating, by the system (e.g., remediator component 322), a suggested policy in response to the unapproved impact being determined to be counter to a known function associated with the unapproved impact on the computer system, wherein the suggested policy instructs restriction of access between at least part of the API, at least part of another API other than the API, and the computer system.

At operation 908, the process flow 900 can comprise, instructing, by the system (e.g., reporter component 320), that the suggested policy be deployed at the computer system.

At operation 910, the process flow 900 can comprise deploying, by the system (e.g., remediator component 322), the suggested policy at a server that facilitates use of the API via the computer system.

At operation 912, the process flow 900 can comprise directly remediating, by the system (e.g., remediator component 322), a vulnerability of the computer system in response to the unapproved impact being determined to be counter to the known function of the computer system comprising generating instructions that block access to the API via modification to an associated markup language configuration or a corresponding service server configuration.

At operation 914, the process flow 900 can comprise, determining, by the system (e.g., backdoor analyzer component 318), using a directed graph generated to define at least interactions between APIs employing the computer system, comprising the API, that invocation of the other API is dependent upon invocation of the API.

At operation 916, the process flow 900 can comprise, based on a first output from an artificial intelligence process using an analytical model and based on a second output from monitoring interactions between APIs employing the computer system, comprising the API, learning, by the system (e.g., backdoor analyzer component 318), learning that invocation of the other API is dependent upon invocation of the API.

At operation 918, the process flow 900 can comprise, based on a determination that the computer system is a framework-based system that self-loads and executes code, monitoring, by the system (e.g., backdoor analyzer component 318), using an analytical model (e.g., analytical model 324), at least one of unapproved impacts to the computer system and approved impacts to the computer system as a result of execution of code by the framework-based system.

At operation 920, the process flow 900 can comprise based on the monitoring, learning, by the system (e.g., analytical model 324), a dependency between the API and the other API.

For simplicity of explanation, the computer-implemented methodologies and/or processes provided herein are depicted and/or described as a series of acts. The subject innovation is not limited by the acts illustrated and/or by the order of acts, for example acts can occur in one or more orders and/or concurrently, and with other acts not presented and described herein. The operations of process flows of the FIGS. provided herein are example operations, and there can be one or more embodiments that implement more or fewer operations than are depicted.

Furthermore, not all illustrated acts can be utilized to implement the computer-implemented methodologies in accordance with the described subject matter. In addition, the computer-implemented methodologies could alternatively be represented as a series of interrelated states via a state diagram or events. Additionally, the computer-implemented methodologies described hereinafter and throughout this specification are capable of being stored on an article of manufacture to facilitate transporting and transferring the computer-implemented methodologies to computers. The term article of manufacture, as used herein, is intended to encompass a computer program accessible from any machine-readable device or storage media.

In summary, described herein relates to managing backdoor vulnerabilities of a computer system. A system for the managing can comprise a processor, and a memory that stores executable instructions that, when executed by the processor, facilitate performance of operations, comprising analyzing system information relating to operation of an application programming interface (API); based on a result of the analyzing of the system information, constructing a call function for execution of the API and executing the call function; based on monitoring a data flow of the system with respect to the execution of the API, generating impact data representative of an impact of the execution of the API; and determining whether the impact is counter to historical functioning of the system as represented by historical functioning data.

An example benefit of one or more of the above-indicated method, system and/or non-transitory computer-readable medium can be an automatic vulnerability monitoring framework that can be triggered automatically upon invocation of an API, at any suitable frequency, and/or when manually triggered. The framework can account for one or more deficiencies of existing manual frameworks, including latency, manual labor, error prone user entity decision making and expense based on actual monetary cost, bandwidth, power and/or the like.

Another example benefit of one or more of the above-indicated method, system and/or non-transitory computer-readable medium can be proactive notification of a vulnerabilities detection and temporary remediation of the vulnerability. In this way, while a user entity (e.g., administrator entity or engineer entity) is reviewing the notification, constructing a patch, testing the patch, submitting the patch for approval, and/or deploying the patch, the temporary remediation can black access to an API of interest or by the API of interest to a respective computer system at which the API operates.

Still another example benefit of one or more of the above-indicated method, system and/or non-transitory computer-readable medium can be an ability to track and/or learn API-to-API dependencies, API relations, API operations and/or operation of malicious code unrelated to API invocation. This can be beneficial in cases where a single API invocation does not elicit use of a malicious code, but where invocation of two or more APIs in a sequence or at least partially in parallel does elicit use of the malicious code. In another example, this can be beneficial where an API schema document or an API source code is unavailable for review by the framework, and thus malicious code behavior is to be learned using a bottom-up approach. In still another example, this can be beneficial where a malicious code functions unrelated to an executed API, but rather can be a longer running thread and/or process.

Indeed, in view of the one or more embodiments described herein, a practical application of above-indicated method, system and/or non-transitory computer-readable medium can be an ability to automatically determine a vulnerability to a computer system due to a malicious code absent manual review of API schemas and/or source code by a user entity. Furthermore, the one or more embodiments described herein can perform the determination by comparison of results of invoked APIs against historical functioning of the computer system, and/or or against sets of specified (e.g., known) malicious code and/or malicious code-related programs, websites, files, etc. This is a useful and practical application of computers, thus providing enhanced (e.g., improved and/or optimized) operation of the hardware and/or software components for monitoring backdoor vulnerabilities. Overall, such tools can constitute a concrete and tangible technical and/or physical improvement in the field of computer system security.

Furthermore, one or more embodiments described herein can be employed in a real-world system based on the disclosed teachings. For example, one or more electronic structure embodiments described herein can function with a computer system and/or one or more servers for internet, cloud and/or internal/external networks to analyze vulnerabilities and/or to remediate such vulnerabilities. Such information can be employed by a backdoor vulnerabilities analysis system described herein to maintain security of a computer system by executing one or more processes that perform data comparison, API invocation, graph generation, report generation and/or remediation execution.

Moreover, a system and/or method described herein can be implemented in one or more domains to enable any one or more of scaled monitoring, analysis and/or remediation, at least partially in parallel with one another, of one or more vulnerabilities at least partially in parallel with one another.

Further, one or more embodiments described herein are inherently and/or inextricably tied to computer technology and cannot be implemented outside of a computing environment. For example, one or more processes performed by one or more embodiments described herein can more efficiently, and even more feasibly, monitor, analyze and/or remediate a backdoor vulnerability of a computer system as compared to existing systems and/or techniques. Systems, computer-implemented methods and/or computer program products facilitating performance of these processes are of great utility in the field of computer system security and cannot be equally practicably implemented in a sensible way outside of a computing environment. Indeed, inputs and/or outputs of a system and/or method described herein can be digitally/electronically communicated.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively operate processes that perform data comparison, API invocation, graph generation, report generation and/or remediation execution as the one or more embodiments described herein can facilitate these processes. And, neither can the human mind nor a human with pen and paper automatically perform one or more of the processes as conducted by one or more embodiments described herein.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not described herein for the sake of brevity, but known by those of skill in the art.

In one or more embodiments, one or more of the processes described herein can be performed by one or more specialized computers (e.g., a specialized processing unit, a specialized classical computer, and/or another type of specialized computer) to execute defined tasks related to the one or more technologies describe above. One or more embodiments described herein and/or components thereof can be employed to solve new problems that arise through advancements in technologies mentioned above, employment of cloud operation systems, computer architecture and/or another technology.

One or more embodiments described herein can be fully operational towards performing one or more other functions (e.g., fully powered on, fully executed and/or another function) while also performing the one or more operations described herein.

### Example Operating Environment

FIG. 11 is a schematic block diagram of an operating environment 1100 with which the described subject matter can interact. The operating environment 1100 comprises one or more remote component(s) 1110. The remote component(s) 1110 can be hardware and/or software (e.g., threads, processes, computing devices). In one or more embodiments, remote component(s) 1110 can be a distributed computer system, connected to a local automatic scaling component and/or programs that use the resources of a distributed computer system, via communication framework 1140. Communication framework 1140 can comprise wired network devices, wireless network devices, mobile devices, wearable devices, radio access network devices, gateway devices, femtocell devices, servers, etc.

The operating environment 1100 also comprises one or more local component(s) 1120. The local component(s) 1120 can be hardware and/or software (e.g., threads, processes, computing devices). In one or more embodiments, local component(s) 1120 can comprise an automatic scaling component and/or programs that communicate/use the remote resources 1110 and 1120, etc., connected to a remotely located distributed computing system via communication framework 1140.

One possible communication between a remote component(s) 1110 and a local component(s) 1120 can be in the form of a data packet adapted to be transmitted between two or more computer processes. Another possible communication between a remote component(s) 1110 and a local component(s) 1120 can be in the form of circuit-switched data adapted to be transmitted between two or more computer processes in radio time slots. The operating environment 1100 comprises a communication framework 1140 that can be employed to facilitate communications between the remote component(s) 1110 and the local component(s) 1120, and can comprise an air interface, e.g., interface of a UMTS network, via an LTE network, etc. Remote component(s) 1110 can be operably connected to one or more remote data store(s) 1150, such as a hard drive, solid state drive, subscriber identity module (SIM) card, electronic SIM (eSIM), device memory, etc., that can be employed to store information on the remote component(s) 1110 side of communication framework 1140. Similarly, local component(s) 1120 can be operably connected to one or more local data store(s) 1130, that can be employed to store information on the local component(s) 1120 side of communication framework 1140.

### Example Computing Environment

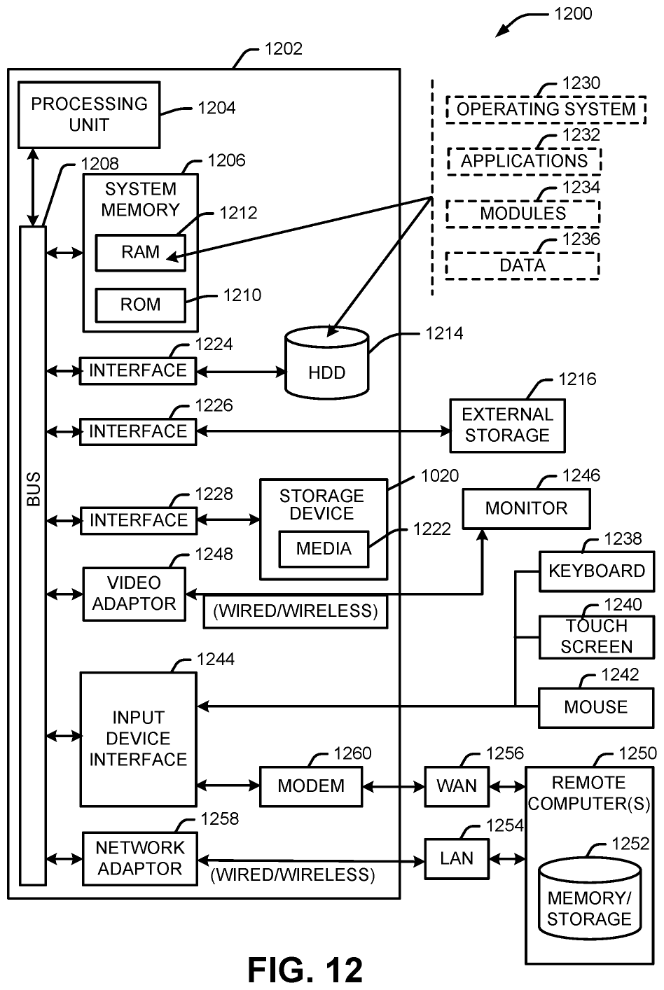

In order to provide additional context for various embodiments described herein, FIG. 12 and the following discussion are intended to provide a brief, general description of a suitable computing environment 1200 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform tasks or implement abstract data types. Moreover, the methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, exclude only propagating transitory signals per se as modifiers and do not relinquish rights to all standard storage, memory or computer-readable media that are not only propagating transitory signals per sc.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

Referring still to FIG. 12, the example computing environment 1200 which can implement one or more embodiments described herein includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes ROM 1210 and RAM 1212. A basic input/output system (BIOS) can be stored in a nonvolatile memory such as ROM, erasable programmable read only memory (EPROM), EEPROM, which BIOS contains the basic routines that help to transfer information between elements within the computer 1202, such as during startup. The RAM 1212 can also include a high-speed RAM such as static RAM for caching data.

The computer 1202 further includes an internal hard disk drive (HDD) 1214 (e.g., EIDE, SATA), and can include one or more external storage devices 1216 (e.g., a magnetic floppy disk drive (FDD) 1216, a memory stick or flash drive reader, a memory card reader, etc.). While the internal HDD 1214 is illustrated as located within the computer 1202, the internal HDD 1214 can also be configured for external use in a suitable chassis (not shown). Additionally, while not shown in computing environment 1200, a solid-state drive (SSD) could be used in addition to, or in place of, an HDD 1214.

Other internal or external storage can include at least one other storage device 1220 with storage media 1222 (e.g., a solid-state storage device, a nonvolatile memory device, and/or an optical disk drive that can read or write from removable media such as a CD-ROM disc, a DVD, a BD, etc.). The external storage 1216 can be facilitated by a network virtual machine. The HDD 1214, external storage device 1216 and storage device (e.g., drive) 1220 can be connected to the system bus 1208 by an HDD interface 1224, an external storage interface 1226 and a drive interface 1228, respectively.

The drives and their associated computer-readable storage media provide nonvolatile storage of data, data structures, computer-executable instructions, and so forth. For the computer 1202, the drives and storage media accommodate the storage of any data in a suitable digital format. Although the description of computer-readable storage media above refers to respective types of storage devices, other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. The systems and methods described herein can be implemented utilizing various commercially available operating systems or combinations of operating systems.

Computer 1202 can optionally comprise emulation technologies. For example, a hypervisor (not shown) or other intermediary can emulate a hardware environment for operating system 1230, and the emulated hardware can optionally be different from the hardware illustrated in FIG. 12. In such an embodiment, operating system 1230 can comprise one virtual machine (VM) of multiple VMs hosted at computer 1202. Furthermore, operating system 1230 can provide runtime environments, such as the Java runtime environment or the NET framework, for applications 1232. Runtime environments are consistent execution environments that allow applications 1232 to run on any operating system that includes the runtime environment. Similarly, operating system 1230 can support containers, and applications 1232 can be in the form of containers, which are lightweight, standalone, executable packages of software that include, e.g., code, runtime, system tools, system libraries and settings for an application.

Further, computer 1202 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1202, e.g., applied at the application execution level or at the operating system (OS) kernel level, thereby enabling security at any level of code execution.

A user can enter commands and information into the computer 1202 through one or more wired/wireless input devices, e.g., a keyboard 1238, a touch screen 1240, and a pointing device, such as a mouse 1242. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera, a gesture sensor input device, a vision movement sensor input device, an emotion or facial detection device, a biometric input device, e.g., fingerprint or iris scanner, or the like. These and other input devices are often connected to the processing unit 1204 through an input device interface 1244 that can be coupled to the system bus 1208, but can be connected by other interfaces, such as a parallel port, an IEEE 1394 serial port, a game port, a USB port, an IR interface, a BLUETOOTH® interface, etc.

A monitor 1246 or other type of display device can also be connected to the system bus 1208 via an interface, such as a video adapter 1248. In addition to the monitor 1246, a computer typically includes other peripheral output devices (not shown), such as speakers, printers, etc.

The computer 1202 can operate in a networked environment using logical connections via wired and/or wireless communications to one or more remote computers, such as a remote computer 1250. The remote computer 1250 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1252 is illustrated. The logical connections depicted include wired/wireless connectivity to a local area network (LAN) 1254 and/or larger networks, e.g., a wide area network (WAN) 1256. Such LAN and WAN networking environments are commonplace in offices and companies, and facilitate enterprise-wide computer networks, such as intranets, all of which can connect to a global communications network, e.g., the Internet.

When used in a LAN networking environment, the computer 1202 can be connected to the local network 1254 through a wired and/or wireless communication network interface or adapter 1258. The adapter 1258 can facilitate wired or wireless communication to the LAN 1254, which can also include a wireless access point (AP) disposed thereon for communicating with the adapter 1258 in a wireless mode.

When used in a WAN networking environment, the computer 1202 can include a modem 1260 or can be connected to a communications server on the WAN 1256 via other means for establishing communications over the WAN 1256, such as by way of the Internet. The modem 1260, which can be internal or external and a wired or wireless device, can be connected to the system bus 1208 via the input device interface 1244. In a networked environment, program modules depicted relative to the computer 1202 or portions thereof, can be stored in the remote memory/storage device 1252. The network connections shown are example and other means of establishing a communications link between the computers can be used.

When used in either a LAN or WAN networking environment, the computer 1202 can access cloud storage systems or other network-based storage systems in addition to, or in place of, external storage devices 1216 as described above. Generally, a connection between the computer 1202 and a cloud storage system can be established over a LAN 1254 or WAN 1256 e.g., by the adapter 1258 or modem 1260, respectively. Upon connecting the computer 1202 to an associated cloud storage system, the external storage interface 1226 can, with the aid of the adapter 1258 and/or modem 1260, manage storage provided by the cloud storage system as it would other types of external storage. For instance, the external storage interface 1226 can be configured to provide access to cloud storage sources as if those sources were physically connected to the computer 1202.

The computer 1202 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a defined structure as with a conventional network or simply an ad hoc communication between at least two devices.

### CONCLUSION

The above description of illustrated embodiments of the one or more embodiments described herein, comprising what is described in the Abstract, is not intended to be exhaustive or to limit the described embodiments to the precise forms described. While one or more specific embodiments and examples are described herein for illustrative purposes, various modifications are possible that are considered within the scope of such embodiments and examples, as those skilled in the relevant art can recognize.

In this regard, while the described subject matter has been described in connection with various embodiments and corresponding figures, where applicable, other similar embodiments can be used or modifications and additions can be made to the described embodiments for performing the same, similar, alternative, or substitute function of the described subject matter without deviating therefrom. Therefore, the described subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions described herein. Processors can exploit nano-scale architectures to optimize space usage or enhance performance of user equipment. A processor can also be implemented as a combination of computing processing units.

As used in this application, the terms “component,” “system,” “platform,” “layer,” “selector,” “interface,” and the like are intended to refer to a computer-related entity or an entity related to an operational apparatus with one or more functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with functionality provided by mechanical parts operated by electric or electronic circuitry, which is operated by a software or a firmware application executed by a processor, wherein the processor can be internal or external to the apparatus and executes at least a part of the software or firmware application. As yet another example, a component can be an apparatus that provides functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of these instances.

While the embodiments are susceptible to various modifications and alternative constructions, certain illustrated implementations thereof are shown in the drawings and have been described above in detail. However, there is no intention to limit the various embodiments to the one or more specific forms described, but on the contrary, the intention is to cover all modifications, alternative constructions, and equivalents falling within the spirit and scope.

In addition to the various implementations described herein, other similar implementations can be used, or modifications and additions can be made to the described implementation for performing the same or equivalent function of the corresponding implementation without deviating therefrom. Still further, multiple processing chips or multiple devices can share the performance of one or more functions described herein, and similarly, storage can be implemented across different devices. Accordingly, the various embodiments are not to be limited to any single implementation, but rather are to be construed in breadth, spirit, and scope in accordance with the appended claims.

What is claimed is:

1. A system, comprising:
a processor; and
a memory that stores executable instructions that, when executed by the processor, facilitate performance of operations, comprising:
analyzing system information relating to operation of an application programming interface (API);
based on a result of the analyzing of the system information, constructing a call function for execution of the API and executing the call function;
based on monitoring a data flow of the system with respect to the execution of the API, generating impact data representative of an impact of the execution of the API; and
determining whether the impact is counter to historical functioning of the system as represented by historical functioning data.

2. The system of claim 1, wherein the analyzing of the system information comprises analyzing source code corresponding to the API or analyzing a schema document associated with the API.

3. The system of claim 1, wherein the generating the impact data comprises monitoring outgoing system traffic, initiating a system process and generating a system file.

4. The system of claim 1, wherein the determining whether the impact is counter to the historical functioning of the system comprises comparing data associated with an initiated system process or a generated system file, initiated by execution of the API, to a selected database comprising data defining known malicious processes, malicious files or both.

5. The system of claim 1, wherein the operations further comprise:
in response to the determining indicating that the impact is counter to the historical functioning of the system, determining a vulnerability of the system resulting from the executing of the call function, and transmitting vulnerability information defining the vulnerability to a device associated with an administrator entity of the system.

6. The system of claim 1, wherein the operations further comprise:
in response to the determining indicating that the impact is counter to the historical functioning of the system, remediating a vulnerability of the system comprising initiating execution of instructions that block access to the API via modification of a markup language configuration associated with the API or of a service server configuration corresponding to the API.

7. The system of claim 1, wherein the operations further comprise:
in response to determining that the analyzing of the system information has failed due to an inability to analyze source code corresponding to the API or a schema document associated with the API, conducting monitoring of the system over a defined period of time for outgoing system traffic, initiating a system process or generating a system file; and
based on data obtained from the monitoring, performing the constructing of the call function.

8. A non-transitory machine-readable medium, comprising executable instructions that, when executed by a processor, facilitate performance of operations, the operations comprising:
generating a directed graph defining discovered application programming interfaces (APIs) associated with a computer system;
traversing, in a data environment, the directed graph and identifying an outgoing edge or an incoming edge of the directed graph;
constructing a function call for an API of the discovered APIs and executing the function call;
establishing an impact of the execution by monitoring a data flow of the system; and
determining whether the impact is counter to a known functioning of the system.

9. The non-transitory machine-readable medium of claim 8, wherein the generating of the directed graph further comprises constructing, for the directed graph, a group of vertices corresponding to the discovered APIs and mapping interactions between the vertices, and wherein the outgoing edge or the incoming edge represents a pair of vertices of the group of vertices where invocation of a first vertex of the pair is dependent upon invocation of a second vertex of the pair.

10. The non-transitory machine-readable medium of claim 8, wherein, for an API of the discovered APIs, the identifying of the outgoing edge or the incoming edge of the directed graph further comprises fetching a downstream source field value corresponding to the outgoing edge or the incoming edge; and
constructing the function call for the API employing the downstream source field value as target field value of the function call.

11. The non-transitory machine-readable medium of claim 8, wherein the operations executed by the processor further comprise:
for an API of the discovered APIs, remediating a vulnerability of the computer system in response to the impact being counter to the known functioning of the system by generating and implementing instructions that block access to the API via modification to an associated markup language configuration or to a corresponding service server configuration.

12. The non-transitory machine-readable medium of claim 8, wherein the operations executed by the processor further comprise:
employing an analytical model that, based on impacts to the system as a result of execution of call functions for the APIs, learns a dependency between a first API of the APIs and a second API of the APIs, resulting in a learned dependency,
wherein, based on the learned dependency, the constructing of the function call for the API comprises selecting the first API or the second API as the API, resulting in a selected API, and constructing the function call for the selected API.

13. The non-transitory machine-readable medium of claim 12, wherein the operations executed by the processor further comprise:
monitoring, using the analytical model, an access log of an API gateway or associated server facilitating function of the computer system,
wherein the generating of the directed graph comprises defining the learned dependency in the directed graph.

14. The non-transitory machine-readable medium of claim 12, wherein the operations executed by the processor further comprise:
training the analytical model based on training input comprising source field values of pairs of dependent APIs of the discovered APIs.

15. A method, comprising:
detecting, in a data environment of a computer system operatively coupled to a processor, an unapproved impact on the computer system as a result of an execution of a call function associated with an application programming interface (API) known to the computer system,
wherein detecting the unapproved impact comprises detecting a defined unapproved effect on outgoing system traffic, an initiation of system process or a generation of a system file;
generating, by the system, a suggested policy in response to the unapproved impact being determined to be counter to a known function associated with the unapproved impact on the computer system, wherein the suggested policy instructs restriction of access between at least part of the API, at least part of another API other than the API, and the computer system; and
instructing, by the computer system, that the suggested policy be deployed at the computer system.

16. The method of claim 15, further comprising:
determining, using a directed graph generated to define at least interactions between APIs employing the computer system, comprising the API, that invocation of the other API is dependent upon invocation of the API.

17. The method of claim 15, further comprising:
based on a first output from an artificial intelligence process using an analytical model and based on a second output from monitoring interactions between APIs employing the computer system, comprising the API, learning that invocation of the other API is dependent upon invocation of the API.

18. The method of claim 15, further comprising:
deploying, by the computer system, the suggested policy at a server that facilitates use of the API via the computer system.

19. The method of claim 15, further comprising:
in addition to generating the suggested policy, directly remediating a vulnerability of the computer system in response to the unapproved impact being determined to be counter to the known function of the computer system comprising generating instructions that block access to the API via modification to an associated markup language configuration or a corresponding service server configuration.

20. The method of claim 15, further comprising:
based on a determination that the computer system is a framework-based system that self-loads and executes code, monitoring, using an analytical model, at least one of unapproved impacts to the computer system and approved impacts to the computer system as a result of execution of code by the framework-based system; and
based on the monitoring, learning, by the system, a dependency between the API and the other API.
